(19) United States
(12) Patent Application Publication
(10) Pub. No.: US 2022/0343397 A1
(43) Pub. Date: Oct. 27, 2022

(54) AUTOMATED LOCATION BASED TEXT TO VOICE ORDERING NOTIFICATION SYSTEM

(71) Applicant: DinnerStar, Inc., Portland, OR (US)

(72) Inventors: David Kolar, Portland, OR (US); Earl Dahildahil, Iloilo (PH)

(21) Appl. No.: 17/726,399

(22) Filed: Apr. 21, 2022

Related U.S. Application Data
(60) Provisional application No. 63/177,729, filed on Apr. 21, 2021.

(51) Int. Cl. G06Q 30/06; G06Q 10/08

(52) U.S. Cl. CPC G06Q 30/0635; G06Q 30/0641; G06Q 10/087; G06Q 10/083

(57) ABSTRACT

Systems and methods are described for automated order notifications and voice order generation. A method for generating order notifications may include obtaining location information of a user device. A list of menu items from various vendors may be generated and provided to the user device based on the location information. Responsive to receiving an order, a conversion service may convert the order information to audio to generate a voice order, where the voice order is submitted to a vendor device associated with the vendor to place the order. The user may be notified that the vendor has received/accepted the order. Based on receiving a first notification from the user device indicating that the user device is located proximate to the vendor, a second notification may be sent to the vendor indicating that the order user device is proximate to the vendor and that the order is ready to be fulfilled.

### CROSS-REFERENCE TO RELATED APPLICATIONS

This application claims the benefit of U.S. Provisional Patent Application No. 63/177,729, filed Apr. 21, 2021, the disclosure of which is incorporated herein by reference in its entirety.

### BACKGROUND

Traditionally, merchants and restaurants have routinely taken orders by phone and fulfilled these consumer orders upon their arrival to their stores and places of business. It is now commonplace for consumers (or consumers or shoppers or buyers) to purchase restaurant meals and other merchant products from client-server based (or on-line or e-commerce or Internet-based) third-party suppliers and platforms or directly from the online presence of restaurants and merchants on the internet. Technology has leapfrogged the traditional in favor a complicated process that lacks simplicity, which to many is a deficiency disguised as progress. Many restaurants and merchants prefer to accept orders by phone. While consumers enjoy the anonymity of placing orders via mobile and web, placing orders via web and mobile can force unwanted processes and investments on merchants. Additionally, consumers picking up orders at a merchant prefer speed and anonymity.

The marketplace has concentrated on aspects of this order process from an online perspective only. Restaurants and other merchants have been challenged to keep up with computerized and other systems to serve the increasingly complicated technical landscape of ordering and support. In view of the foregoing, a need exists for a system that is easier to use and adaptable by merchants that do not have or do not want to support complicated online ordering and order processing.

### BRIEF DESCRIPTION OF THE DRAWINGS

Various techniques will be described with reference to the drawings, in which:

FIG. 1 illustrates an example of an automated ordering notification system interacting with a consumer device and a vendor device, according to at least one embodiment;

FIG. 2 illustrates an example process to generate order notifications, such as may be performed by the automated ordering notification system of FIG. 1, according to at least one embodiment;

FIGS. 3-6 illustrate example views of a graphical user interface that may be provided to a consumer device, such as by the automated ordering notification system of FIG. 1, according to at least one embodiment; and

FIG. 7 illustrates an example process for generating one or more order notifications, according to at least one embodiment.

### DETAILED DESCRIPTION

Systems and methods are described herein for generating notifications to efficiently process orders for goods and services, and in particular for food items from restaurant providers. In some aspects, an automated ordering notification system may interface with user devices to provide a streamlined ordering process from any of a number of different vendors. A user interface application may be installed on a user or consumer device to interface with the notification system. In some aspects, a vendor application may be installed on one or more vendor computing machines to also interface with the automated ordering notification system; however, as will be described in more below, an important advantage of the described systems and methods is that they can interface with any vendor system, including basic phone based ordering systems, to integrated ordering applications (e.g., Otter, Door Dash, etc.), and anything in between, based on the processes used by the automated ordering notification system. The automated ordering notification system may utilize location information from a consumer device to identify nearby vendors (e.g., restaurants, or other vendors as may be specified by the user). The automated ordering notification system may generate a menu of items that may be purchased by the user, such as organized by vendor, location, type of goods (e.g., type of food), etc., and send this menu or list to the user device. The automated ordering notification system may pull the menu item information, images, etc., from a database or datastore of such items as maintained by the automated ordering notification system, or it may pull the information from vendor websites, Google maps, information, and the like. The consumer, through the user device, may select items for purchase and/or pay for the items using the application.

Upon receiving the order information, the automated ordering notification system may gather the order information and communicate the order to the specific vendor, utilizing contact information of the vendor (e.g., such as simply a phone number or mobile phone number, email address, etc.). The automated ordering notification system may convert the order information into a text or SMS message, email, and/or to voice to be communicated to the vendor via the contact information associated with the order. In some cases, a third party or separate service may be utilized to provide this conversion process. In other cases, the automated ordering notification system may provide this functionality natively.

The vendor may confirm that they have received the order, either through completion of a voice call or through an indication or selection provided by a vendor application on a vendor computing device. In some cases, the vendor application may enable the vendor to provide updates as to the status of the order, including when the order is expected to be completed or fulfilled and when it is actually ready for the consumer. In some cases, the automated ordering notification system may obtain updated location information from the user device and convey that information to the vendor, such that the vendor can process and prepare the consumer's order to be complete by the time the consumer arrives at the vendor to pick up the order. In some cases, the user may indicate via a selection in the user application that they have arrived at the vendor for pickup of the items ordered. In some cases, additionally or alternatively, the user application may provide for a flashing screen with an order number indicated on the screen, such that the user can place the device executing the application in a place where an employee of the vendor can see the device and readily identify the user and deliver the items to the user. In yet some cases, a geofence or other location information may be used to automatically notify the vendor that the user is proximate to the vendor, whereby the geofence information may be utilized to more precisely locate the user to deliver the ordered items to the user (e.g., curbside pickup).

In some cases, the automated ordering notification system may also configure and provide selection options to the user device via the user application, indicating different delivery options for the ordered items to be delivered to the user. The automated ordering notification system may enable various vendors to select if they wish to provide deliveries to consumers. In this scenario, the automated ordering notification system may track locations of delivery drivers or delivery agents associated with each vendor and may send a notification to the delivery drivers once an order has been placed, to deliver the order to the consumer. The automated ordering notification system may interface with the drivers directly, on behalf of the vendor, or may enable direct communications between the driver, the vendor, and/or the consumer to facilitate delivering the order to the specified location and provide updates to the consumer as to status of the order and/or delivery.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

As one skilled in the art will appreciate in light of this disclosure, certain embodiments may be capable of achieving certain advantages, including some or all of the following: (1) an adaptable integration system that enables users to place online orders for vendors that do not support online orders, via an order generation and conversion to audio communication process (2) more efficient utilization of computing resources to enable users to find and order goods and services based on location; and (3) other advantages as will be made apparent in the rest of this disclosure. As will be appreciated by the remainder of this disclosure, the described systems and techniques provide for a widely adaptable and intuitive system for consumers and vendors to use alike. The described systems and techniques may interface with vendor systems of varying complexity, including simple phone ordering capabilities, to fully integrated systems and delivery options to provide the user or consumer a unified searching an ordering interface for selecting goods and services to acquire.

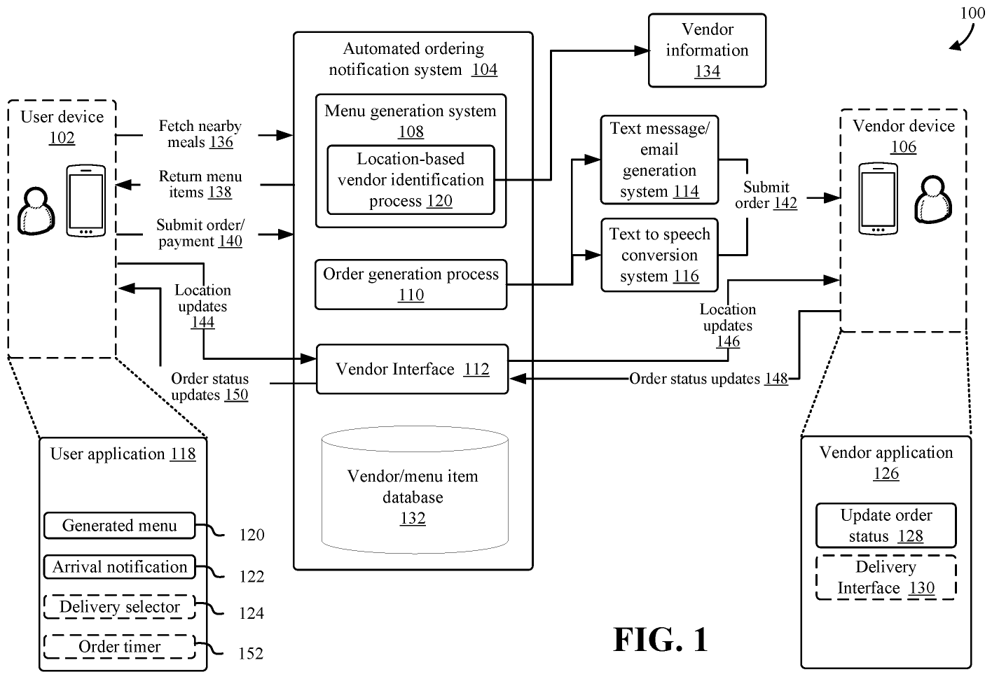

FIG. 1 illustrates an example 100 of an automated ordering notification system 104 interacting with a user or consumer device 102 and a vendor device 106. The automated ordering notification system 104 may interact with various user devices 102, various vendor devices 106, one or more systems or services that generate text messages or audio or voice calls 114, 116, and/or various online resources and information about various vendors 134 through one or more networks to provide ordering functionality and provide notifications to consumers and vendors alike.

The automated ordering notification system 104 may be a collection of computing resources, including physical resources, virtual resources, or combinations thereof, configured to obtain, direct, and otherwise manage various communications between various computing devices including one or more user devices 102 and one or more vendor devices 106, and in some cases, one or more delivery agent devices (not shown) to facilitate processing orders and providing notifications to these entities. In some cases, the automated ordering notification system 104 may provide services and notifications to user devices 102 and vendor devices 106 that may be accessible through various software, hardware, and/or variations thereof. In some examples, the services may be implemented as software applications or services executing on various computing devices. Examples of such computing devices include one or more instances of a physical computing instance (e.g., a physical server computer, a mobile communication device, a laptop computer, a tablet computer, a personal computer, a mainframe, etc.) or one or more instances of a virtual computing instance, such as a virtual machine hosted on one or more computer servers, or other various capable computing systems.

In some aspects, the automated ordering notification system 104 may include a menu generation system 104. The menu generation system 104 may be a collection of computing resources configured to acquire data relating to various items for sale by one or more vendors and generate a list of these items to enable efficient selection of one or more items by a consumer through a user device 102. The menu generation system 104 may compile a list of items for sale by vendors according to a location of the user device 102 or a selected location received from the user device 102. The location information can be obtained automatically, such as by acquiring global positioning system (GPS) or other coordinates of the user device 102, such as when the user device is a mobile device. In other cases, a selected location may be received from the user device 102, such as an intended destination, proximate to which the consumer desires to acquire goods or services. Based on this location information, which may take any of a variety of formats and including various identifiers of a location, such as street address, area defined by a radius around a selected coordinate, etc., the menu generation system 104 may execute a location-based vendor identification process 120 to identify vendors proximate to the received location information. In some cases, location-based vendor identification process 120 may search the internet, such as via a mapping application such as Google Maps, Apple maps, etc., to identify nearby vendors satisfying search criteria received from the user device 102 (e.g., types of goods or services desired, specifics as to the goods desired, such as type of food, etc.). In other cases, the location-based vendor identification process 120 may access a vendor/menu item database 132 to identify nearby vendors that have previously registered or provided information to the automated ordering notification system 104.

In some cases, the vendor/menu item database 132 may include one or more hardware storage devices, as maintained and managed by the automated ordering notification service 104. In other cases, the vendor/menu item database 132 may include cloud-based storage devices or services, such as may be provided by third party computing resource service providers and accessed by the automated ordering notification system 104. The vendor/menu item database 132 may service API requests to store and retrieve data objects synchronously, and may be configured to store various forms of data and media, and other data structures generated and updated by the automated ordering notification system 104 relating to supported vendors, contact information of those vendors, hours, etc., and items and related information of those items that are provided by the vendors for purchase by consumers, including descriptions and/or media of the items, prices of the items, availability of those items, etc. The vendor/menu item database 132 may be implemented on a computer system, or abstraction thereof (such as one or more virtual machines, software containers, or other computing resource abstractions), implemented using hardware and software, and may comprise one or more processors and memory that stores executable instructions whose execution by the one or more processors causes the computer system to perform operations described herein. In some examples, data stored in the vendor/menu item database 132, may be organized into data objects, which may have arbitrary sizes and may. Access to the vendor/menu item database 132 may be through application programming interface (API) calls to the database or service or via an interface, such as a GUI. It should be appreciated that the vendor/menu item database 132 may additionally or alternatively provide non-object-based data storage, such as block data storage, table-oriented data storage, relational databases, file-based storage, and the like.

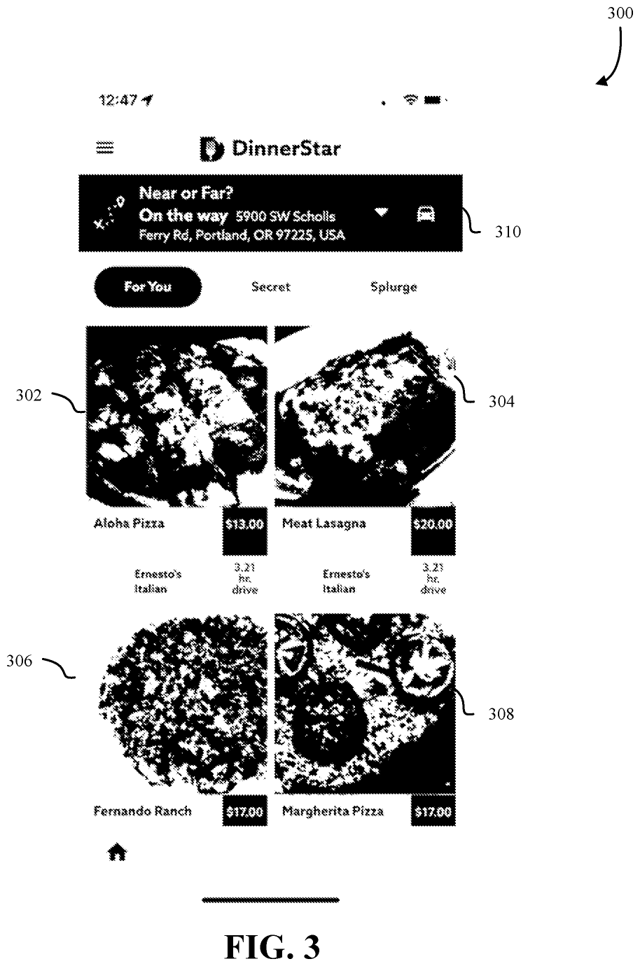

Once the location-based vendor identification process 120 has identified one or more vendors satisfying a search criterion provided by the user device 102, the menu generation system 104 may acquire item details from these vendors. In some cases, the item information may be acquired from a vendor/menu item database 132. In yet some cases, the item information may be acquired from vendor information 134 obtained from various other sources, including web crawling vendor websites, Google Maps menu information, and/or various other sources. In some cases, both of these sources may be used to acquire item details for a given search. In yet other cases, additional or alternative data sources may be utilized. The menu generation system 108 may then compile the various items and send them to the user device, to cause the menu items to be displayed to the user via a graphical user interface (GUI) provided by the user device 102. An example of a menu item GUI will be described in greater detail below in reference to FIG. 3. In some examples, the menu items from one or more vendors may be displayed to the suer in a uniform way, enabling the user to make a selection of one or more items for purchases.

Upon receiving a completed order from the user device, in some cases including payment, the automated ordering notification system 104 may generate an order using an order generation process 110. In some cases, order generation process 110 may extract certain pieces of information contained in the order to generate an order that can be sent to a vendor. In some cases, the order generation process 110 may extract contact information, such as a phone number and/or email address of the vendor specified in the received order, to be able to direct the order to the correct destination or vendor. In some cases, the order generation process 110 may generate one or more data structures so that a vendor system, such as provided by a vendor device, such as a point of sale (POS) system, may be able to ingest and properly process the order. In some cases, this may include formatting certain pieces of information contained in the order, including items, quantities, prices, pick up or delivery time or other options. In yet some cases, the order generation process 110 may generate one or more data structures so that a text message/email generation system or service 114, and/or a text to speech or audio generation system or service 116 may be able to generate an order or a notification thereof, that is readily consumable by the vendor system.

In some cases, text message/email generation system 114, and/or the text to speech conversion system 116 may be separate systems or services, apart from the automated ordering notification system 104, such as provided by a third-party vendor. In other cases, one or both of the text message/email generation system 114, and/or the text to speech conversion system 116 may be provided by the automated ordering notification system. In some cases, the order generation process 100 may access vendor preferences via the vendor/menu item database to determine what forms of order delivery or notification are preferred by certain vendors, and in some cases, additional requirements specified by the vendors for receiving orders. In some cases, a vendor may provide contact information and specific notification preferences.

In one example, a vendor, that is only equipped with a dial up or mobile phone (e.g., the vendor device includes a mobile device or dial up phone), may specify voice or audio only notification. In this scenario, the order generation process 100 may format the order information in such a way as to be consumable by a text to speech conversion system 116. Upon receiving the order information, the text to speech conversion system 116 may generate an audio recording or stream of the order, and place a call to the vendor device 106 using the vendor provided contact information. The call may be provided over any of a variety of networks, as is known in the art. Additionally, the text to speech conversion system may utilize existing technologies to generate the audio order. In this way, the vendor may receive the order via the vendor device 106 and enter the order (e.g., manually) into a vendor POS system. This use of the automated ordering notification system 104 may enable the greatest flexibility in interfacing with basically any vendor, regardless of their technical capabilities. This feature of the automated ordering notification system 104 may enable a greater number vendors to be accessed by consumers using the automated ordering notification system 104 without requiring the vendor to change any of their existing systems or integrate any new work flows or processes.

In another example, the vendor may specify a text message and/or email delivery of the order. In a similar way as described above, the order generation process 120 may generate an order in a format and including information that is consumable by a text message/email generation system 114 to generate a text or SMS message and/or an email to a vendor device 106 to place an order with the vendor. A text or SMS message and/or email, may similarly provide a great amount of flexibility to interface with a wide variety of vendors, as the vendor can just manually input the order details into any existing POS system, as they would do with other types and origins of orders. In yet some cases, multiple of text message, email, and/or audio or voice may be used to notify the vendor device 106 of an order.

In yet some examples, a vendor may install a vendor application 126 on a vendor device 106, which is configured to enable the vendor device 106 to provide updates on the order and/or configure deliveries for the order back to the automated ordering notification system 104. In yest some cases, the vendor application 126 may interface with the vendor POS system such as to automate order placement with the vendor POS system to further streamline the ordering process. In yet some cases, the automated ordering notification system 104 may interface with other integration systems (e.g., Otter or Door Dash) to provide greater functionality and provide additional benefits as to seamless integration with existing vendor systems that are already set up to interface with these services.

In any of the above examples, confirmation of receipt of an order by the vendor device 106 may be provided in any of a number of different ways. In the audio call example, completion of the call may automatically trigger the text to speech conversion system 116 and/or the automated ordering notification system 104 to provide a notification to the user device 102 that the order has been placed and is being processed. This type of notification may also be utilized in the text message and email notification schemes as well. In yet some cases, a vendor may, through a vendor device 106 confirm receipt of the order and/or provide updates as to the status of the order, back to the automated ordering notification system 104, such as via a vendor interface 112. The vendor interface 112 may act as a relay between the vendor device 106 and the user device 102, processing and forwarding order status updates and/or location updates of the user device, to aid the vendor in determining when to prepare the order for pickup (end in some cases, transport the order for curbside pickup).

In some aspects, the automated ordering notification system 104 may also receive delivery options from the vendor and provide selection items to the user application 118 via delivery selector 124. In this scenario, the automated ordering notification system 104 may maintain delivery agents or driver information, such as in the vendor/menu item database 132. Upon receiving an order, the vendor device 106 may access a delivery interface 130, which may be a system or process configured to identify delivery agents nearby and available and send an email t them with at least some of the order details, including pick-up and delivery time and vendor and consumer locations. In some aspects, the driver agent may also have a separate application executing on their mobile device, which may be provided by the automated ordering notification system 104, that enables the delivery agent to confirm receipt and accept a delivery job. In some aspects, a read receipt, once the delivery agent has accessed the order email on their device, may be send to the vendor as confirmation of acceptance of the order. The vendor device 106 may then coordinate with the user device to inform the user of scheduled delivery time and other updates. In some cases, the vendor through the vendor device 106/delivery interface 130 may determine which areas they are willing to provide delivery services to—which will cause the automated ordering notification system 104 to update what delivery options are available to the user device 102 via the delivery selector 124 of the user application 118. In some cases, the delivery selector 124 may be updated in real time or near real time based on the location of the user device 102 and/or a selected delivery location obtained from the user device 102. In this way, the automated ordering notification system 104 may provide for a seamless integration of delivery services to the ordering process, without requiring much if any change to vendor systems.

As described herein, the user device 102 may refer to a consumer computer system or computing device connected to a server (e.g., automated ordering notification system 104) over a network. The user device 102 may be a mobile device, such as a smart phone or tablet, a laptop, desktop, or any other computing device capable of connecting to one or more networks. In some cases, user device 102 refers to a user or consumer of the automated ordering notification system 104. The user device 102 may interact with the automated ordering notification system 104 over one or more networks to order and obtain items provided by any of a variety of vendors.

The user device 102 may execute an application or program 118, that is provided through or by the automated ordering notification system 104, to interface with various vendors 106 and order goods and services. The user application 118 may have a number of different selections and graphical user interfaces (GUIs) to enable the user to select, order, pay for, and receive updates or notifications concerning orders for goods and services. In some aspects, the user application 118 may provide a generated menu of items 120 for purchase, such as may be provided by the automated ordering notification system 104. The user application 118 may also provide for selections for one or more arrival notifications 122, such that the user device can notify a vendor when the user is in a location to pick up goods from the vendor. In some cases, the user application 118 may also include a delivery selection interface 124, whereby the user or consumer can select one or more options to have the goods delivered to specified location. More details of the user application 118 and associated interfaces will be described in greater detail below in reference to FIGS. 3, 4, 5, and 6.

In at least one embodiment, user device 102 interacts with a GUI to interact with various data provided by or through the automated ordering notification system 104 and one or more vendors, and client-side software translates the GUI setup to a web service API request which is transmitted from the user device 102 to the automated ordering notification system 104 over one or more networks. The network may include any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In some cases, a network may include or refer specifically to a telephone network such as a public switched telephone network or plain old telephone service (POTS).

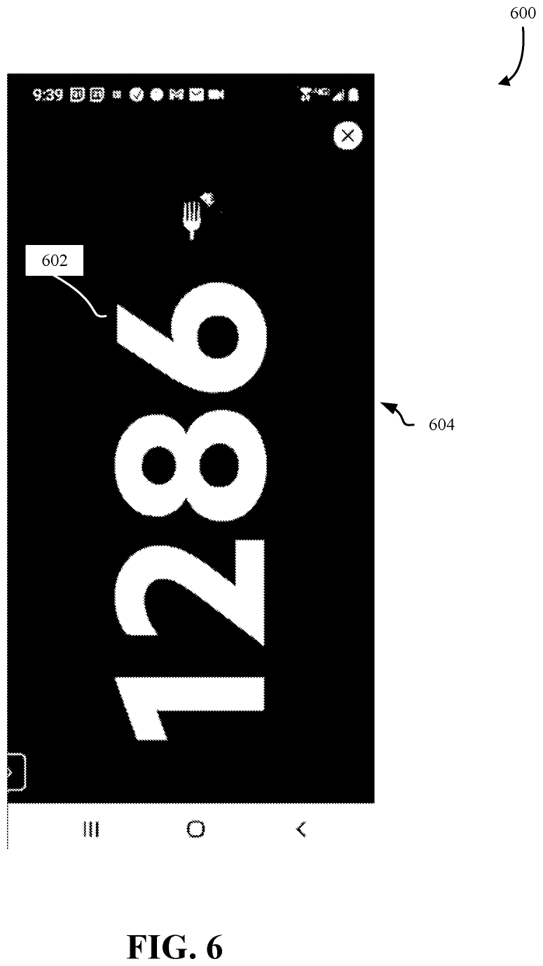

In some cases, the automated ordering notification system 104 may provide an order completion timer or counter to the user device 102, to inform the user more precisely when an order is to be completed by a vendor and either ready for pick up at the vendor's location, or when a delivery will be made to a location specified by the user. In some aspects, the order timer or counter 152 may be provided as a graphical element in the user application 118. An example of an order timer is illustrated and described below in reference to FIG. 6.

In some aspects, the vendor may select between various options to notify the user device of order status and completion and/or delivery time. In some cases, these options may be input using update order status functionality 128 provided in vendor applicator 126. In some cases, the vendor may select a completion based on general parameters (e.g., a certain item or items in an order will generally take this long to complete), or may set a specific completion for a specific order, such as based on traffic at the vendor's location, items ordered, and various other factors. Once a timer or counter is set by the vendor though the vendor device 106, the timer amount may be communicated to the user device 102, such as through vendor interface 112 or directly to the user device 102, in some cases. Once the timer starts running, it may inform the user of when it will be ready for pickup at the vendor's location or delivered to a specified location.

In some cases, the timer value may be updated in real time or near real time by changes in order status submitted by the vendor device. In some cases, this may be performed automatically (such as based on changes in the order status of an order as input by a vendor), or based on a number of triggering events (e.g., when an order is indicated as completed, or if there are delays in processing the order. In some cases, the timer functionality may be optimized using a variety of methods, such as artificial intelligence (e.g., adjusting or setting default completion times for orders based on historical information, of similar prior orders, time of day, location of vendor, etc.), and in some aspects, based on computational from geo-tracking, travel times, etc.

As described herein, the timer function, arrival notification, order status updates, and various other features provided by and described herein of the automated ordering notification system 104 may provide a number of advantages, including optimizing the consumer experience to continuously reduce customer waiting times at pickup, and also aiding in improving accuracy and communication thereof of vendor timing and order completion.

Vendor device 106 may refer to a vendor computer system or computing device connected to a server (e.g., automated ordering notification system 104) over a network. The vendor device 106 may include a dial up phone, a mobile device or smart phone, tablet, a laptop, desktop, or any other computing device capable of connecting to one or more networks (including in some cases, a dial up network). The vendor device 106 may execute an application or program 126, that is provided through or by the automated ordering notification system 104, to interface with various consumers to process orders for goods and services. In some, but not all cases, such as where the vendor device 106 is a smart phone or other device that is capable of connecting to the internet, the vendor device 106 may provide a vendor application 126. The vendor application may provide for an interface or selection items for updating status of an order from a consumer. The statuses may include, received, in process, completed, and the various other status updates that indicate to a consumer, various attributes of processing an order.

In some cases, the vendor application may additionally include a delivery interface 130. The delivery interface 130 may enable vendors to configure options relating to delivering goods to consumers. In some cases, the delivery interface 130 may enable a vendor agent to search for and select delivery agents to delivery ordered goods to consumers. In other cases, the delivery interface 130 may coordinate automatically with a pool of agents to deliver items to a consumer location. In some cases, an agent of a pool of agents may be selected based on a location of the vendor, and a location of the delivery to consumer. In some cases, the vendor may select a delivery area (e.g., defined by distance from a vendor location, travel time to a consumer location, or other metrics affecting delivery or vendor preferences, such as certain neighborhoods or areas, etc.), for which deliveries may be made available to consumers. In some cases, the vendor may configure these options, such that a delivery option will only be made available to a consumer through the user application 118 if the vendor has enabled deliveries and the delivery location is within an accepted area defined by the vendor.

In some aspects, the vendor device 106 may include a desktop or laptop computing device, where the vendor application 126 is formatted for these devices. In some cases, the vendor application 126, when operating on a desktop or laptop computing device, may enable a vendor to either manually or, with additional integrations, automatically interface with the vendor's POS system more readily and with less inputs. In these examples, the vendor application 126 may be executed on an existing computing device associated with the vendor that also executes the POS system of the vendor. In these cases, the vendor application 126 may be configured to interface directly with the POS system, such that when an order is received via the vendor application 126, it is automatically loaded into the vendor's POS system, thus reducing the amount of input steps needed for the vendor to process and complete the order. In yet other cases, a vendor agent may manually transfer the order details (e.g., items and quantities, payment, etc.) from the vendor application 126 to the vendor POS system. In yet some cases, the vendor application 126 may interface with another system (e.g., Otter, Door Dash, etc.), and that system may then interface with the vendor POS system. In this example, particularly when the vendor already supports these third party providers, no additional integrations may be necessary to utilize the benefits of the automated ordering notification system 104.

An example of operation of the automated ordering notification system 104 will now be described. A user device 102 may submit a request 136 to fetch nearby goods and services, such as restaurant items or meals, to purchase, through a suer application 118 to the automated ordering notification system 104. The request 136 may include the current location of the user device or an intended pickup or delivery location for the goods or services. The request 136 may additionally include search parameters for what type of goods or services the consumer desires, such as what type of food, or other attributes of food, such as cost, time that the food takes to prepare, hours of the vendor, etc. the consumer desires. The menu generation system 108 of the automated ordering notification system 104 may then identify nearby vendors based on the location information using the location-based vendor identification process 120, and obtain, compile, and/or generate a list of items provided by the identified vendors, according to the search parameters received in the request. The automated ordering notification system 104 may return the list of items in a message 138 back to the user device. The user device may then receive order information and/or payment information and submit an order 140 to the automated ordering notification system 104.

Upon receiving the order, the automated ordering notification system 104 may, using the order generation process 110, generate an order request to be sent to one or more of a text messaging/email generation system 114, and/or a text to speech conversion system 116, where the system used is selected based on vendor preferences stored and accessed in the vendor/menu item database 132. The text messaging/email generation system 114, and/or the text to speech conversion system 116 may then communicate the order at operation 142 to a vendor device, according to the contact information associated with the vendor. The vendor device 106 may communicate one or more order status updates 148, 150 to the user device 102, either directly, or as illustrated through the vendor interface 112 provided by the automated ordering notification system 104. The user device 102 may, such as automatically, send one or more location updates 144, 146 back to the vendor device 106 either directly or through the vendor interface 112 provided by the automated ordering notification system 104. In some cases, the user device 102 may communicate an arrival notification, such as though the arrival notification element 122 of the user application 118 to indicate to the vendor that the user is at the vendor location and is ready to pick up the order. In some aspects, the arrival notification 122 may be generated automatically by the user application based on a location of the user device 102 being within a certain distance of the vendor location. In some cases, the user application may generate one or more visual indicators to be sued to alert the vendor of the precise location of the user device (e.g., a flashing screen in the user application 118.

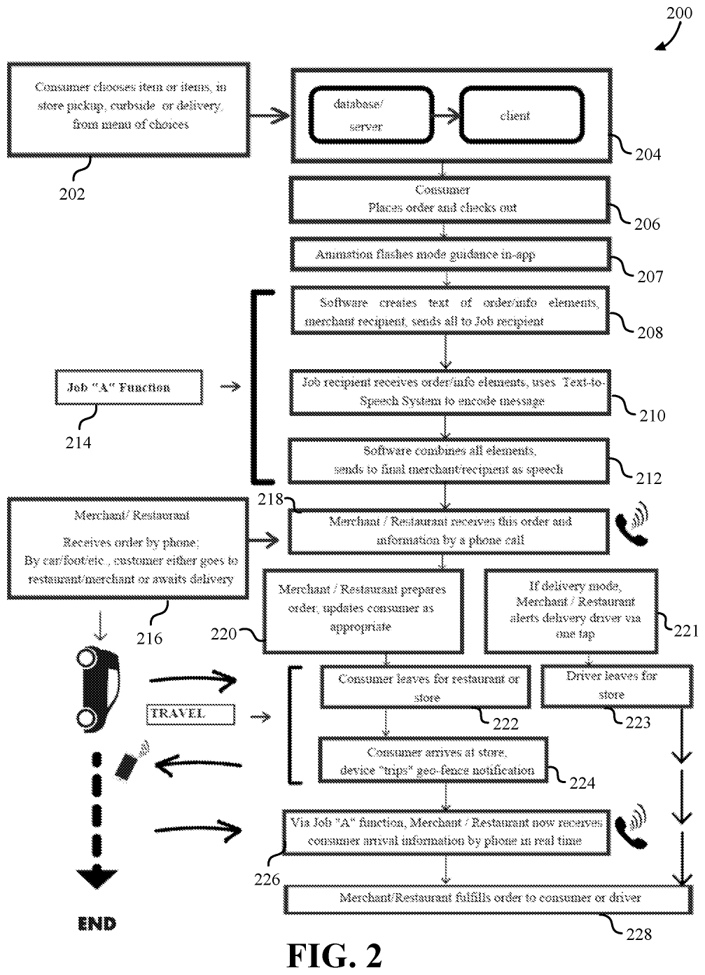

FIG. 2 illustrates an example process 200 to generate order notifications, such as may be performed by the automated ordering notification system 104 of FIG. 1. An example user experience, and an example of operations of the automated ordering notification system 104 will be described in reference to FIG. 2. While some embodiments can relate to ordering and pickup of food from a restaurant, further embodiments can relate to orders from users related to various goods and/or services, which can be provided by various merchants. Accordingly, the following examples and the examples of the FIG. 2 should not be construed as limiting. As used herein vendor and merchant may be used interchangeable to refer to the same entity or device.

Process 200 will be described below first from the perspective of the user or user experience. At operation 202, the user via a user device, such as user device 102, can be provided with a variety of options on a screen via a mobile device or a web page. These can be any item at all in various embodiments, described with words, descriptions and/or pictures. In one instance, one or more restaurant meals and options are provided for the user to choose from. The user can choose an item or items from the array presented and proceeds to the next phase. At operation 204, the user product choices can be stored in a client/server configuration and arrangement with a database, such as may be provided by the vendor/menu item database 132 and/or by the automated ordering notification system 104. Such a database can house descriptions of items, pictures, prices and other elements that may be routinely used to provide one or more choice to the user. In various embodiments, a user can request or be presented with any suitable number of items for review and possible purchase through a suer device. At operation 206, the user can make a final selection or selections from the menu of choices via user device 102, can enter payment and/or credit card information and can check out and purchases the items. A purchase confirmation can be provided to the user once a transaction has been verified.

In some optional aspects, the mobile application, which may include one or more aspects as user application 118 described above in reference to FIG. 1, may generate an automated notification item, such as part of a GUI provided by the user application, that may instruct the user on the next step in the process of completing an order for goods or services from a vendor or merchant, at operation 207. In some cases, this notification or guidance may include a banner at the top of the GUI of the user applications, which may include some flashing or color changing element to catch the user's attention. In this way, the process may be made more intuitive for a user to follow and complete. This notification may be updated as steps in the order process 200 are completed and new actions are needed to be performed by the user/actions are being performed by the system.

Operations 208, 210, 212 may be collectively referred to as job “A” function 214. Invisible to user, in some embodiments, the merchant or vendor can be notified of the order elements and the user can be made aware that the merchant is being notified of order elements. The automated ordering notification system 104 may execute the job “A” function 214, which creates text of order details at operation 208, sends the created text to a text-to-speech system that generates audio associated with the text of the order at operation 210, and “calls” the merchant with the order at operation 212. For example, the system can dial a phone number associated with a landline or cell phone of the merchant, the merchant can answer the call at operation, and the audio associated with the text of the order, which may or may not include one or more of: an introduction message and other order details such as user name, order number or identifier, confirmation number, user phone number, and the like.

At operation 216, such as may be performed while, during and/or after order is transmitted to merchant, the user can travel to the merchant's physical place of business to claim their order. Transport can be by foot, car, bus or other method. The user can be invited to activate a tracking monitor to notify merchant of their pending arrival, or such tracking may occur automatically. At operation 218, invisible to user, the merchant receives an automated phone call with order details from the application on behalf of the user in the form of an audio presentation over the phone. At operation 220, the merchant prepares the order to the requirements of the user, and can update the user through a notification system on changes to the order or its availability or timing. Such updates can be presented to the user via a mobile device, through a suer application, such as user application 116.

In some aspects, the user arrives at merchant via at operations 222, and 224 and can be invited to let merchant know they have arrived via a notification system if they have not done so earlier. Job A functionality 214 may send an arrival notification, at operation 226 to the merchant, which in some embodiments can be an automated phone call which presents audio the merchant (e.g., “user John Smith has arrived to pick up order 1234.”). In some aspects, if the user arrives and activates arrival notification, the merchant can be notified that user has arrived, and can accelerate gathering of ordered items to user wherever they are in the vicinity, as part of operation 226. The merchant may then finish compiling the order elements and hands order off to the user, wherever the user may be, at operation 228.

In some optional cases, the automated ordering notification system 104 may provide for delivery of goods or services to a location specified by the user. In this case, and upon selection of delivery by the user via the user or mobile application, process 200 may in parallel to operation 220, also perform operation 221, in which one or more delivery agents or drives, such as are within a certain proximity to the merchant, may be notified. In some cases, the merchant may simply select an option in the vendor application 126 that may automatically send order details to nearby delivery drivers and upon a confirmation by a delivery driver, may allocate the order for delivery and notify the user. The order may then be completed and handed off to the delivery driver, who may proceed, at operation 223 to leave the merchant and deliver the goods to the user to fulfill the order, at operation 228.

From the perspective of the automated ordering notification system 104, the mobile application, which may include one or more aspects of user application 118 and/or be provided by the automated ordering notification system 104, sends a fetch request from the automated ordering notification system 104 to get a list of meals based on the user's current location (e.g., identified by a location of a user device utilized by the user) and target destination. The mobile application then receives the data as meals and then displays it to the user (e.g., via the mobile application on a user device). The user may then select items or meals, add them to the cart, and then pay for the order via credit card or other suitable payment method, at operations 202, 204, 206. However, in some embodiments, the user can elect to pay for the order upon pickup and deal with the vendor or merchant directly. On successful payment (in embodiments that include pre-payment), the mobile application can submit an order request to the automated ordering notification system 104. The automated ordering notification system 104 can then notify the merchant about the new order through the mobile application's push notification feature. Asynchronously, additional requests can be created by the mobile application using a third-party text and text-to-speech service provider to further notify the merchant aside from the push notification, at operations 208, 210, and 212. These will each be described in turn below.

In some cases, an SMS or text message notification may be generated or caused to be generated by the automated ordering notification system 104. Order information such as meal/extra names, quantity ordered, payments, and the user's estimated arrival time can be generated in the background as a single string and then attach it to an API request as data. The merchant's registered mobile number may be attached on the API request as the recipient. In some cases, the user's mobile application, such as application 118 and/or the automated ordering notification system 104 described above, may compile this information and submit the request to the third-party service provider's SMS API. The third-party service provider may receive this request and then translate the “data” on the request as the text and the recipient as the target of its SMS service. The third-party service provider may then send a text message to the restaurant/vendor.

In some cases, a voice or audio notification (e.g., transmitted by a call over one or more telephone or voice over IP networks) may be generated or caused to be generated by the automated ordering notification system 104. Order information such as meal/extra names, quantity ordered, payments, and the user's estimated arrival time can be generated in the background as a single string and then attach it to the API request as data. The restaurant's registered mobile number (or other vendor contact information) can be attached on the API request as the recipient. The user mobile application, such as application 118 and/or the automated ordering notification system 104 described above, can compile this information and can submit the request to the third-party service provider's voice calling API. The third-party service provider may receive this request and can then translate the data on the request as the text and the recipient as the target of its voice calling service. The third-party service provider calls the restaurant and then reads the text using their Text-To-Speech technology (i.e., presents audio to the person who receives the telephone call).

The merchant/restaurant can receive the new order information through the application/system push notification, text message, and/or phone call, at operations 216, 218. The merchant/restaurant can confirm and update the order status using the vendor application, such as application 126, at operation 220. Operation 220 may also include the merchant/restaurant notifying the user about the order's status by updating an order status on the vendor application. The vendor application can send a push notification to the user. In some aspects, the user's mobile application can automatically notify the merchant/restaurant about the user's current distance, location, and status by sending or more push notifications to the vendor.

The user may arrive at the merchant/restaurant and may notify the merchant/restaurant (e.g., by clicking a “Here Now” button on the mobile application), at operations 222 and 224. In some aspects, the mobile application can send a push notification about the arrival to the restaurant. The merchant/restaurant can give the order to the user and then can complete the order by updating the order's status to completed on the vendor application, at operation 228. The order process can then be deemed complete. User has picked up order and merchant has closed and posted transaction.

FIGS. 3-6 illustrate example views of a graphical user interface that may be provided to a user device, such as by the automated ordering notification system 104 of FIG. 1. FIGS. 3-6 illustrate example views in a user application, such as may be provided via user application 118 through user device 102 as described above.

FIG. 3 illustrates a GUI view 300 that includes various menu items 302, 304, 306, 308 presented in a tile format, including various pieces of information with respect to each item. In the example illustrated, each item may be represented by a picture of the item itself or a representation thereof, along with a title and price, and in some cases time to arrive at the location. View 300 may be an example of generated menu 120 described above in reference to FIG. 1. In some cases, each item may also have an indication of whether it is currently available or not. Any number of different items may be displayed per screen/and others may viewed by scrolling. As also illustrated, a banner 310 may be presented in the upper section of the GUI that indicates the next action to be taken to process or complete the order, as descried in operation 207 of process 200 above. In some aspects, the banner or visual element 310 may include a flashing component or color changing component, such as to draw the user's attention. In some aspects, the banner 310 may flash or change color when the next action indicated in the banner has changed or there is some indication that the action is not being performed (e.g., payment still needs to be completed, driving away from the vendor, etc.).

In some examples, various items from different vendors may be displayed with a uniform theme, format, and look, for a number of reasons, such as to increase user engagement with the application and complete an order, so as to not bias the user from selecting certain items, and for a more pleasant user experience.

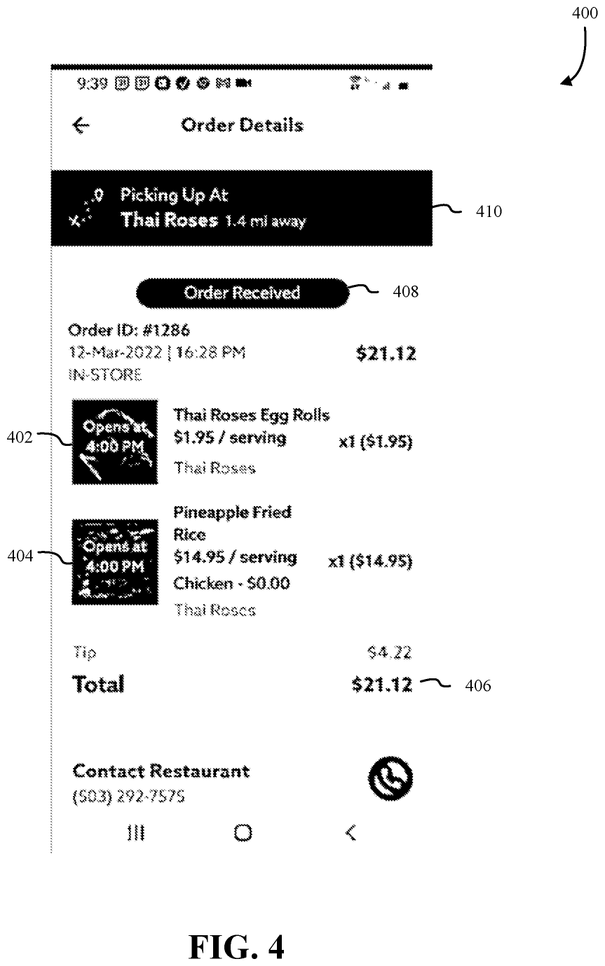

FIG. 4 illustrates a GUI view 400 that includes order details and order status information, which may be updated by the vendor in real or near real time. As illustrated, the order may include two items 420, 404, a total price 406, and a status update indicator 408, which in the illustrated example, indicates that the order has been received. View 400 may also include a next actions banner or element 410, which may include one or more aspects of the banner 310 described above in reference to FIG. 3. View 400 may display various other information as may be deemed useful to a suer to complete and pickup an order.

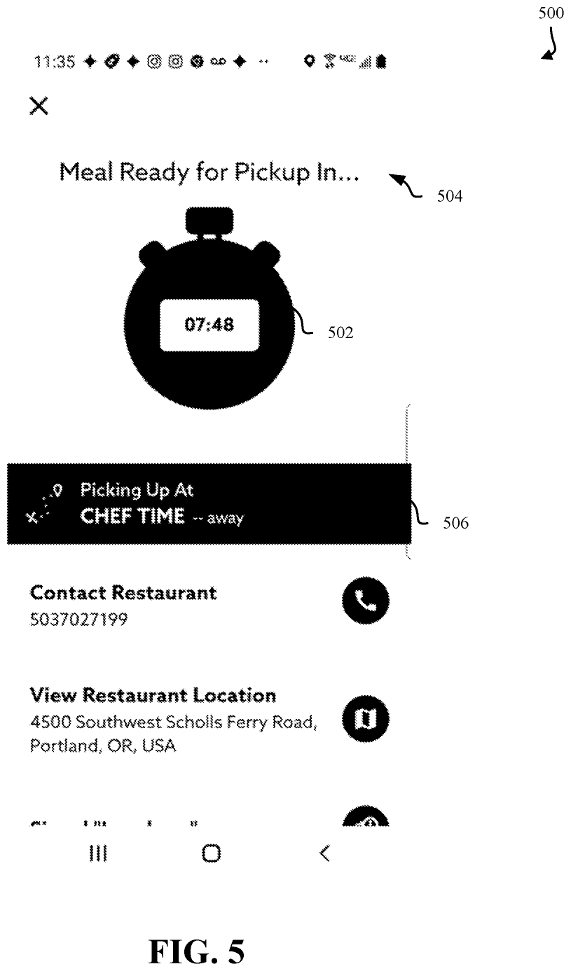

FIG. 5 illustrates a GUI view 500 that includes an indication 502, 504 of a timer or count down until an order is expected to be ready for pickup (or in some cases delivery) from a vendor. As illustrated, the timer 502 may include a clock or other symbol or icon representative of time, and a digital (or analogue) display of time, such as “7:48” as illustrated. In some cases, the timer 502 may also be associated with a label or banner 504 that indicates what the time references—such as a time until the order is ready for pickup. In some cases, the timer and/or label 502, 504 may be located in an upper portion of the screen, to draw attention to the timer, such as places above an instruction indicator 506 (which may be similar to banner 410 described above in reference to FIG. 4). In some aspects, the time value may initially be set by the vendor, such as based on an actual time the order is to be completed, or based on an approximate time the order is to be completed. In some cases, the timer may be set according to the type of items placed in the order (e.g., a burrito takes 15 minutes to complete). In other cases, the timer may be set initially at a standard value base don items in the order and modified based on business of the vendor or based on other factors (e.g., an employee is out on lunch break, so the order will take longer to prepare). In yet some cases, the timer may be set or adjusted based on status updates from the vendor concerning the order. In this way, a suer may have more information to better time picking up an order (or being present for an order that is to be delivered to a user location).

FIG. 6 illustrates a GUI view 600 that includes an enlarged order number 602. The enlarged order number may be displayed such that a use can hold up their user device, such as a smart phone or tablet, to clearly display their order number, such as when sitting in a car waiting for curbside delivery. In some cases, the order number may be surrounded by a blank or single color screen 604 that is different than a color of the order number, to highlight and increase visibility of the order number 602. In some cases, the entire screen 604 or just the order number 602 may flash or change colors so as to attract the attention of a vendor agent, to help them more easily identify the user to deliver the order to the location of the user. In some aspects, this notification may be beneficially utilized with an automatic notification system (e.g., based on location) that alerts the vendor when the user device is within a certain range of the vendor and is thus ready to pick up an order. In some cases, the order number 602 and/or blank background 604 may span a large portion of the screen, such as a majority of the screen (e.g., more than 50%), or most of the screen (e.g., spanning 70% to approximately 95 or 100% of at least one dimension of the screen). In some cases, the order number 602 and/or blank background 604 may span a majority or more of both dimensions (length and width) of the screen. In other cases, the order number 602 and/or blank background 604 may span only a portion of the screen of the user device.

It should be appreciated that GUI views 300, 400, 500, and 600 described above are only given by way of example to illustrate various features provided by the described system, and that the examples should not be construed as limiting.

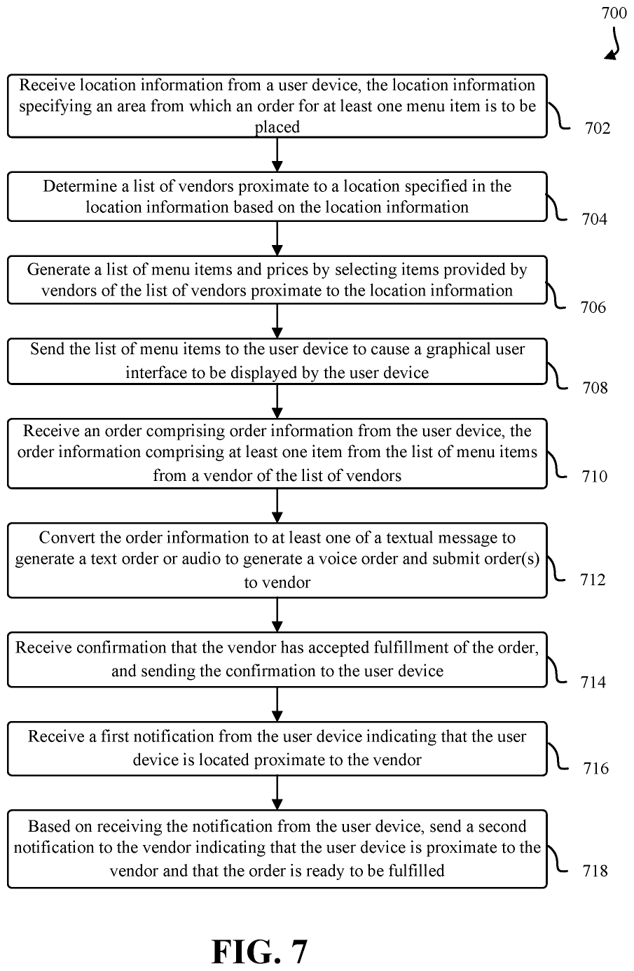

FIG. 7 illustrates an example process 700 for generating notifications to process and enable fulfillment of an order between a user device and a vendor. Process 700 may be performed by the automated ordering notification system 104 and components or systems thereof, as described above in reference to FIG. 1. In some aspects, operations of process 700 may be performed by a user device and/or a vendor service, such as user device 102 and vendor device 106 described above as well.

Process 700 may begin at operation 702, in which an automated ordering notification system may receive or obtain location information from a user device, the location information specifying an area from which an order for at least one menu item is to be placed. In some aspects, the location information may be automatically obtained through a GPS or other location based system operating on or with consent of the device. Next at operation 704, the automated ordering notification system may determine a list of vendors proximate to a location specified in the location information based on the location information. In some cases, operation 704 may include consulting vendor information accessible on the web and/or vendor information maintained by the automated ordering notification system.

At operation 706, the automated ordering notification system may generate a list of menu items and prices by selecting items provided by vendors of the list of vendors proximate to the location information, such as by utilizing vendor information accessible on the web and/or vendor information maintained by the automated ordering notification system. At operation 708, the automated ordering notification system may send the list of menu items to the user device to cause a graphical user interface to be displayed by the user device, such as including GUI view 300 described above.

At operation 710, the automated ordering notification system may receive an order including order information from the user device, the order information specifying at least one item from the list of menu items from a vendor of the list of vendors. Next, at operation 712, the automated ordering notification system itself, or the automated ordering notification system in conjunction with one or more text/speech conversion systems or services may convert the order information to a textual message to generate a text order, and/or convert the order information to a audio to generate a voice order, and submit the order(s) to a vendor device associated with the vendor to place the order.

At operation 714, the automated ordering notification system may receive confirmation that the vendor through the vendor device has accepted fulfillment of the order and may forward the confirmation to the user device. Next, at operation 716, the automated ordering notification system may receive, a first notification from the user device indicating that the user device is located proximate to the vendor (e.g., has arrived at the vendor location). At operation 718, the automated ordering notification system, based on receiving the notification from the user device, may send a second notification to the vendor indicating that the user device is proximate to the vendor and that the order is ready to be fulfilled.

In some cases, the first notification may be automatically generated by the user device based on a current location of the user device being within a certain distance of the vendor. In some aspects, the automated ordering notification system may cause the user device to display the order number across a majority of the user device so as to readily identify the user device and enable the vendor to fulfill the order, such as described above in reference to view 600 of FIG. 6.

In some aspects, the automated ordering notification system may cause the user device to display a first order status indicating the order is being processed responsive to the automated ordering notification system receiving the confirmation from the vendor. The automated ordering notification system may subsequently receive a status update indicating the order is ready to be fulfilled, and responsive to receiving the status update, may cause the user device to display a second order status indicating that the order is ready for pickup. In some cases, the automated ordering notification system may cause the user device to visually display different instructions based on the order needing additional steps to be complete, the order being received by the vendor, and the order being ready for pickup, such as via a banner or visual element 310, as descried above in reference to GUI view 300 of FIG. 3.

In yet some aspects, the automated ordering notification system may cause the user device to display a delivery option for the order, such as when delivery is enabled by a specific vendor. Upon receiving a selection of the delivery option, the automated ordering notification system may provide a selectable option to the vendor device to send the order information to a delivery device to fulfill delivery of the order, wherein upon selection of the selectable option, the vendor device sends the order information to the delivery device to fulfill the delivery request.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. A computer-implemented method for converting an order to a voice order and providing notifications relating to the order, the method comprising:
receiving, by an automated ordering notification system, location information from a user device, the location information specifying an area from which an order for at least one menu item is to be placed;
determining a list of vendors proximate to a location specified in the location information based on the location information;
generating a list of menu items and prices by selecting items provided by vendors of the list of vendors proximate to the location information;
sending the list of menu items to the user device to cause a graphical user interface including the list of menu items o be displayed by the user device;
receiving an order comprising order information from the user device, the order information comprising at least one item from the list of menu items from a vendor of the list of vendors;
causing a conversion service to:
convert the order information to a textual message to generate a text order;
convert the order information to audio to generate a voice order; and
submit the text order and the voice order to a vendor device associated with the vendor to place the order;
receiving, by the automated ordering notification system, confirmation that the vendor through the vendor device has accepted fulfillment of the order, and sending the confirmation to the user device;
receiving, by the automated ordering notification system, a first notification from the user device indicating that the user device is located proximate to the vendor; and
based on receiving the first notification from the user device, sending a second notification to the vendor indicating that the order user device is proximate to the vendor and that the order is ready to be fulfilled.

2. The computer-implemented method of claim 1, wherein the first notification is automatically generated by the user device based on a current location of the user device being within a certain distance of the vendor, the method further comprising:
causing, by the automated ordering notification system, the user device to display the order number across a majority of the user device so as to readily identify the user device and enable the vendor to fulfill the order.

3. The computer-implemented method of claim 1, further comprising:
causing, by the automated ordering notification system, the user device to display a first order status indicating the order is being processed responsive to the automated ordering notification system receiving the confirmation from the vendor;
receiving, by the automated ordering notification system, a status update indicating the order is ready to be fulfilled;
causing, by the automated ordering notification system, the user device to display a second order status indicating that the order is ready for pickup.

4. The computer-implemented method of claim 1, further comprising:
causing, by the automated ordering notification system, the user device to visually display different instructions based on the order needing additional steps to be complete, the order being received by the vendor, and the order being ready for pickup.

5. The computer-implemented method of claim 1, further comprising:
causing, by the automated ordering notification system, the user device to display a delivery option for the order;
upon receiving a selection of the delivery option, providing, by the automated ordering notification system, a selectable option to the vendor device to send the order information to a delivery device to fulfill delivery of the order, wherein upon selection of the selectable option, causing the vendor device to send the order information to the delivery device.

6. The computer-implemented method of claim 1, further comprising:
receiving a completion time of the order from the merchant device; and
responsive to receiving the completion time, causing, by the automated ordering notification system, the user device to display an order timer that tracks the completion time of the order.

7. A computer-implemented method, comprising:
obtaining location information of a user device, the location information specifying an area from which an order for at least one menu item is to be placed;
generating and providing a list of menu items and prices to the user device by selecting items provided by a set of vendors proximate to a location specified in the location information based on the location information;
receiving an order comprising order information, the order information comprising at least one item from the list of menu items from a vendor of the set of vendors;
causing a conversion service to convert the order information to audio to generate a voice order and submit the voice order to a vendor device associated with the vendor to place the order;
receiving confirmation that the vendor through the vendor device has accepted fulfillment of the order;
receiving a first notification from the user device indicating that the user device is located proximate to the vendor; and
based on receiving the first notification from the user device, send a second notification to the vendor indicating that the order user device is proximate to the vendor and that the order is ready to be fulfilled.

8. The computer-implemented method of claim 7, further comprising:
causing a conversion service to at least one of:
convert the order information to a textual message generate a text order,
or convert the order information to a n email to generate an email order submit the voice order to a vendor device associated with the vendor to place the order; and
submit at least one of the text order or the email order to the vendor device in addition to the voice order.

9. The computer-implemented method of claim 7, wherein the first notification is generated by the user device based on a current location of the user device being within a certain distance of the vendor.

10. The computer-implemented method of claim 6, wherein generating the list of menu items and prices is based on at least one of vendor information obtained from public sources and vendor information maintained by a vendor database.

11. The computer-implemented method of claim 6, further comprising:
causing the conversion service to convert the second notification to audio to generate a voice notification and submit the voice notification to the vendor device associated with the vendor.

12. The computer-implemented method of claim 6, further comprising:
causing the user device to visually display different instructions based on the different order statuses.

13. The computer-implemented method of claim 6, further comprising:
upon receiving a selection of delivery from the user device, providing an option to the vendor device to send the order information to a delivery device to fulfill delivery of the order.

14. A ordering notification system, comprising:
one or more processors; and
memory that stores computer-executable instructions that, if executed, cause the one or more processors to:
receive location information from a user device, the location information specifying an area from which an order for at least one menu item is to be placed;
generate a list of menu items and prices by selecting items provided by a set of vendors proximate to a location specified in the location information based on the location information
send the list of menu items to the user device to cause the list of menu items to be displayed by the user device;
receive an order comprising order information from the user device, the order information comprising at least one item from the list of menu items from a vendor of the set of vendors;
cause a conversion service to:
convert the order information to a textual message to generate a text order; or
convert the order information to a audio to generate a voice order; and
submit at least one of the text order or the voice order to a vendor device associated with the vendor to place the order;
convert the order information to audio to generate a voice order and submit the voice order to a vendor device associated with the vendor to place the order;
receive confirmation that the vendor through the vendor device has accepted fulfillment of the order, and sending the confirmation to the user device;
receive a first notification from the user device indicating that the user device is located proximate to the vendor; and
based on receiving the notification from the user device, send a second notification to the vendor indicating that the order user device is proximate to the vendor and that the order is ready to be fulfilled.

15. The ordering notification system of claim 14, wherein the memory stores additional computer executable instructions that, if executed, further cause the one or more processors to:
cause the conversion service to:
convert the order information to the textual message to generate the text order;
convert the order information to audio to generate the voice order; and
submit the text order and the voice order to the vendor device associated with the vendor to place the order.

16. The ordering notification system of claim 14, wherein the memory stores additional computer executable instructions that, if executed, further cause the one or more processors to:
generate the list of menu items and prices based on at least one of vendor information obtained from public sources and vendor information maintained by a vendor database of the ordering notification system.

17. The ordering notification system of claim 14, wherein the first notification is automatically generated by the user device based on a current location of the user device being within a certain distance of the vendor, wherein the memory stores additional computer executable instructions that, if executed, further cause the one or more processors to:
cause the user device to display the order number across the user device so as to readily identify the user device from a distance and enable the vendor to fulfill the order.

18. The ordering notification system of claim 14, wherein the memory stores additional computer executable instructions that, if executed, further cause the one or more processors to:
cause the user device to display a first order status indicating the order is being processed responsive to the automated ordering notification system receiving the confirmation from the vendor; and
cause the user device to display a second order status indicating that the order is ready for pickup.

19. The ordering notification system of claim 18, wherein the memory stores additional computer executable instructions that, if executed, further cause the one or more processors to:
cause the user device to visually display different instructions based on different order statuses.

20. The ordering notification system of claim 14, wherein the memory stores additional computer executable instructions that, if executed, further cause the one or more processors to:
cause the user device to display a delivery option for the order;
upon receiving a selection of the delivery option, providing a selectable option to the vendor device to send the order information to a delivery service to fulfill delivery of the order, wherein upon selection of the selectable option, causing the vendor device to send the order information to the delivery service.
